(19) United States
(12) Patent Application Publication
(10) Pub. No.: US 2026/0338322 A1
(43) Pub. Date: Oct. 29, 2026

(54) HOLDER FOR FASTENING A LOAD TO A DRY-CONSTRUCTION STRUCTURE, A KIT AND A DRY-CONSTRUCTION STRUCTURE COMPRISING SUCH A HOLDER, AND A METHOD OF FASTENING LOADS TO A DRY-CONSTRUCTION STRUCTURE

(71) Applicant: KNAUF GIPS KG, Iphofen (DE)

(72) Inventor: Zhirayr BADVAGANYAN, Plovdiv (BG)

(21) Appl. No.: 19/118,464

(22) PCT Filed: Nov. 22, 2022
(86) PCT No.: PCT/EP2022/025529

§ 371 Date: Apr. 4, 2025

(51) Int. Cl. F16M 13/02

(52) U.S. Cl. CPC F16M 13/02

(57) ABSTRACT

A holder for fastening a load to a dry-construction structure including a connecting body and a bolt, wherein the connecting body has a first section and a second section, wherein the first section forms a connecting section for connecting to a dry-construction stud, wherein a bolt receptacle is provided for the bolt in the second section wherein the first section and the second section are arranged at an angle with respect to each other is disclosed. The disclosure further relates to a kit including such a holder and to a dry-construction structure having such a holder. The disclosure also relates to a method of fastening loads to a dry-construction structure.

The invention relates to a holder for fastening a load to a dry-construction structure. The holder is particularly suitable for fastening loads to a dry-construction wall, such as in particular a partition wall or a facing shell. However, the holder can also be used for fastening loads to other dry-construction structures. In addition, the invention relates to a kit comprising such a holder and a dry-construction structure comprising such a holder. Furthermore, the invention comprises a method of fastening loads to a dry-construction structure, in particular a dry-construction wall.

A dry-construction structure has a substructure with dry-construction studs to which the planking is fastened. In principle, it is possible to fasten loads directly to the planking. In this respect, it is known to fasten loads with nails. When using so-called X-hooks which are fastened to the planking with nails, loads of 5 kg to 15 kg per hook can be fastened, depending on the design. Furthermore, it is known to attach loads with screws which are inserted directly into the planking. Here, loads of up to about 13 kg per screw can be fastened to a single-layer planking. In the case of two-layer planking with customary planking panels made of gypsum plasterboard, it may be possible to fasten up to 40 kg per screw under certain circumstances. The values can be increased to 50 kg up to 60 kg per screw when using suitable cavity dowels. The loads that can be achieved in each case also depend on the type of planking. When using particularly stable planking panels, the loads can be increased to a some extent.

However, for many fastenings, the above values are not sufficient. This applies in particular to so-called console loads. Console loads are usually secured via several fastening points to the wall. Examples of console loads are hanging-mounted cabinets, hanging-mounted shelves, or other hanging-mounted objects such as water heaters, heating systems or the like. Console loads have a so-called eccentricity, wherein the eccentricity describes the distance of the load resultants to the wall surface. The eccentricity must be taken into account when determining the load-bearing capacity. The greater the eccentricity, the smaller the console loads to be fastened must be for a selected fastening. The maximum permissible console loads are often specified for eccentricities of up to 300 mm. This corresponds, for example, to a uniformly loaded cabinet with a depth of 600 mm.

In order to be able to fasten such higher loads, it has already been suggested to use traverses for fastening which are arranged at the rear side of the planking. The traverses are arranged between two dry-construction studs. There are known traverses that comprise a multi-layered wooden panel on which steel sheet profiles are arranged. The traverse can be connected to the dry-construction studs via the sheet steel profiles. Furthermore, there are traverses known which have a metal plate. Loads can be fastened in each case with screws inserted through the planking into the traverses. Traverses can typically be used to attach loads of up to 150 kg per metre of wall surface.

It is an object of the invention to specify a holder, a kit and a dry-construction structure which allow higher loads to be fastened to the dry-construction structure without the need for traverses. Furthermore, the invention has the task of specifying a method of fastening a load to a dry-construction structure.

The object is solved with a holder having the characteristics of claim 1. Accordingly, a holder for fastening a load to a dry-construction structure is provided, comprising a connecting body and a bolt, wherein the connecting body has a first section and a second section, wherein the first section forms a connecting section for connecting to the dry-construction stud, wherein a bolt receptacle for the bolt is provided in the second section, wherein the first section and the second section are arranged at an angle to each other. This design allows forces to be transferred directly into the substructure. This applies to both, static and dynamic forces. In particular, console loads can also be securely fastened which are connected to the dry-construction structure via several fastening points. One of the holders can be provided at each fastening point. Despite the eccentricity of console loads, i.e., the distance between the load resultants and the wall surface, loads can be securely fastened. This is helped by the fact that the forces are transferred directly into the dry-construction stud. Therefore, the forces do not have to be absorbed by the planking or they have to be absorbed by it to a much lesser extent. The mounting of the holder can be done in a time-saving and secure manner. In addition, the holders allow for great flexibility with regard to the exact height of the fastening, as the holders can be fastened to the dry-construction stud at different heights. Fastening with the holder is also cost-effective, as it only needs to be provided at locations where a load is to be fastened. The holder is flexible in its handling and can be installed by the fitter in the required places. In addition, the holder allows an object to be securely fastened even when vibrations and/or dynamic loads occur.

In the following, preferred embodiments are described which further improve the advantages described above.

Advantageously, it can be provided that the first section has an abutment surface for abutting against the dry-construction support. This contributes to a secure connection between the holder and the dry-construction stud. Preferably, the abutment surface is flat.

Preferably, the second section is arranged at a right angle to the first section.

A particularly preferred embodiment provides that the connecting body has two second sections which are spaced apart from each other. This contributes to a secure connection between the holder and the dry-construction stud. In particular, the maximum load can be increased with this design. Preferably, the bolt is connected to both second sections.

An advantageous embodiment provides that the connecting body is made of one piece of sheet metal. Preferably, the connecting body is bent from one piece of sheet metal so that the first and second sections are arranged at an angle to each other.

Preferably, the connecting body is made of metal. In this case, the connecting body can be made of sheet metal.

According to the invention, it is preferred that the connecting body has a material thickness between 1 mm and 5 mm.

A preferred embodiment provides that the connecting body comprises a connecting web and two connecting legs, wherein the connecting web forms the first section and the connecting legs form the second sections. The connecting legs are preferably each arranged at right angles to the connecting web. According to a particularly preferred embodiment, the connecting body has a U-shape, i.e. is formed as a U-profile.

Preferably, the first section and/or the second section has a rectangular basic shape.

A preferred embodiment provides that a bolt receptacle for the bolt is formed in the connecting body. Preferably, the bolt receptacle is formed in the second section. The bolt receptacle can be formed as an opening in the second section through which the bolt extends. If multiple second sections are provided, the bolt receptacle can be formed by openings of the second sections.

Preferably, the bolt is designed as a screw bolt and has an external thread.

A further improvement can be achieved if the bolt is provided with at least one nut. This way, the bolt can be securely connected to the second section.

It is possible to use a bolt which is designed as a screw bolt with an extended head. In this case, with only one nut, the bolt can be fixed to the second section by clamping the second section between the extended head and the nut.

A preferred embodiment of the invention provides that the bolt is held by two nuts arranged on opposite sides of the second section. Preferably, the two nuts are braced against each other so that the second section is clamped between the nuts. This contributes to a secure fastening.

Another improvement provides that the bolt is connected to each of the second sections. This can be achieved, for example, with two nuts each that clamp the respective second section between them.

An advantageous embodiment provides that the holder (preferably the first section) is associated with a first fastening element for connecting the connecting body to a dry-construction stud. The first fastening element can be used to securely connect the connecting body and the dry-construction stud. In this way, any forces that occur can be safely transferred into the dry-construction stud. Preferably, the connecting body and the dry-construction stud can be braced together by the first fastening element.

Preferably, the first fastening element comprises a screw with a nut. The screw can have an enlarged head. A particularly preferred embodiment provides that the screw has a square neck where the head meets the shank. This facilitates the assembly. With the square neck, a form fit can be achieved with the insertion opening (described in more detail below) of the dry-construction stud so that the screw cannot be rotated relative to the first section. In this case, the nut can be screwed on without having to hold the screw in place with a tool. This allows the use of a truss head screw with a square neck.

According to a further improvement, it can be provided that the connecting body comprises at least one through-opening for the first fastening means. Preferably, the through-opening is arranged in the first section. Preferably, the connecting body has two through-openings. Thus, a first fastening element can be inserted through each one of the two through-openings. This contributes to a secure connection between the holder and the dry-construction stud.

Advantageously, it can be provided that the first fastening element can comprise at least one screw with a screw thread. This allows to brace the connecting body to the dry-construction stud. Preferably, the screw has an enlarged head. Here, it can be provided that the first fastening element comprises at least one nut which, via its nut thread, can be engaged with the screw thread.

A secure fastening is achieved if the bolt is made of metal. Preferably, the bolt is made of steel.

According to the invention, it may further be provided that the bolt has a circular cross-section. The invention further relates to the use of the described holder for securing a load to a dry-construction structure, in particular a dry-construction wall. In particular, the holder can be used for securing a console load to a dry-construction wall.

The underlying task of the invention is further solved by a kit for a dry-construction system comprising a dry-construction stud, wherein the kit further comprises the described holder.

According to the invention, it is preferred if the dry-construction stud has a profiled body with a web and at least one leg. Such dry-construction elements like studs with a respective profiled body are herein also shortly referred to as ‘profile’. Preferably, the profiled body has a web with two legs. In particular, the profiled body can be U-shaped (so called U-profile. It is particularly preferred if the profiled body is formed as a U-stiffening profile, i.e. as a U-shaped, reinforced profiled body.

A preferred embodiment provides that the web of the profiled body has insertion openings for the first fastening elements. Preferably, the insertion openings are formed as slots or oblong holes. This contributes to a safe introduction of forces and also enables height adjustment of the holder.

A preferred embodiment provides that a lower edge of the insertion opening forms a support for the first fastening element. In this way, forces (especially vertical forces) can be introduced directly into the dry-construction stud.

Preferably, the profiled body is made of sheet metal. In particular, the sheet metal may be galvanised.

Preferably, the sheet metal of the profiled body has a sheet thickness between 1 mm and 5 mm. A sheet thickness between 1.5 mm and 2.5 mm is particularly preferred.

Preferably, the dry-construction stud is formed as a dry-construction support. The dry-construction support can be arranged vertically in particular.

The kit can further comprise a dry-construction board for fastening to the dry-construction stud. Preferably, the dry-construction board is a gypsum board, a gypsum plasterboard, a gypsum fibreboard, a cement board, a wood board, or a wood fibreboard.

The underlying task of the invention can further be solved by a dry-construction structure comprising at least one dry-construction stud as well as a planking fastened thereto, wherein the planking has a front side and a rear side, wherein the dry-construction stud is arranged at the rear side of the planking, wherein one of the described holders is provided and fastened to the dry-construction stud by means of a first fastening element, wherein the bolt of the holder extends through the planking from the rear side to the front side.

In particular, the dry-construction structure can be arranged in such a way that the front side faces towards a room and that the rear side faces away from the room.

Preferably, the dry-construction structure is designed as a partition wall or a facing shell. In the case of a partition wall, the dry-construction stud can be provided with planking on both sides. A facing shell can be arranged in front of a wall, wherein the dry-construction studs have planking on the side facing away from the wall.

Preferably, the dry-construction stud is a vertically arranged dry-construction support. The longitudinal direction of the dry-construction support can extend in a vertical direction.

Furthermore, it can be advantageously provided that the at least one dry-construction support extends over the entire height of the dry-construction structure (in particular of the partition wall or facing shell).

A preferred embodiment of the invention provides that the bolt has a section that protrudes by a length A at the front side of the planking. Preferably, the length A is between 10 mm and 30 mm, wherein a length A of more than 15 mm and less than 25 mm is particularly preferred.

Preferably, the bolt has a length between 80 mm and 120 mm.

Preferably, the bolt has a diameter between 10 mm and 15 mm.

A preferred embodiment provides that the planking has a recess, wherein the bolt extends through said recess.

In this case, it is preferred if at least one of the nuts arranged on the bolt is accommodated in the recess. Here, it is preferred if the nut has a thickness that is less than the thickness of the planking. This ensures that the nut does not protrude from the planking on the room side.

Preferably, the planking is formed by the dry-construction boards. These can be provided in a single layer or in multiple layers (in particular two layers).

Preferably, the thickness of the planking is 25 mm or less.

It is further preferred if the recess in the region surrounding the bolt is at least partially filled with a fill material. Preferably, the fill material contains a silicone.

The underlying task of the invention is further solved by a method of fastening an object to a dry-construction structure comprising a dry-construction stud and a planking, comprising the steps of:
fastening a described holder to the dry-construction stud;
creating a recess in the planking;
arranging the planking on the dry-construction stud;
wherein this is done in such a way that the bolt of the holder extends through the recess of the planking and wherein the object is fastened to the bolt.

Preferably, in order to obtain several fastening points, it can be provided that holders are fastened each to one of a plurality of dry-construction studs.

Furthermore, it is preferred if the holder is fastened to the dry-construction stud before the planking is arranged on the dry-construction stud. However, the assembly can also be carried out in a different order.

In particular, the object can form a console load. Preferably, the object is a piece of furniture, such as in particular a hanging shelf or a hanging cabinet, a sanitary appliance, or a component of a heating system.

Further goals, characteristics, advantages, and application possibilities of the present invention result from the following description of exemplary embodiments based on the drawings. All described and/or depicted characteristics, individually or in any meaningful combination, form the object of the invention, even independently of the summary in individual claims or their referrals.

The drawings show:

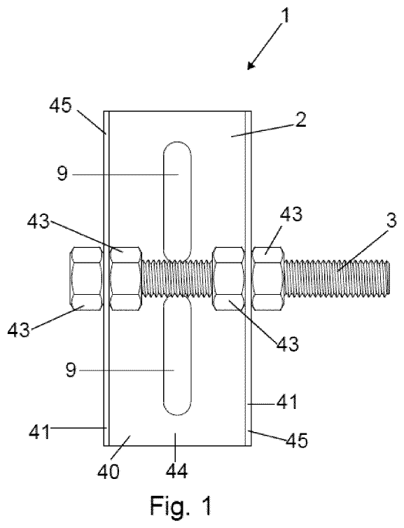

FIG. 1: a holder for fastening a load to a dry-construction structure;

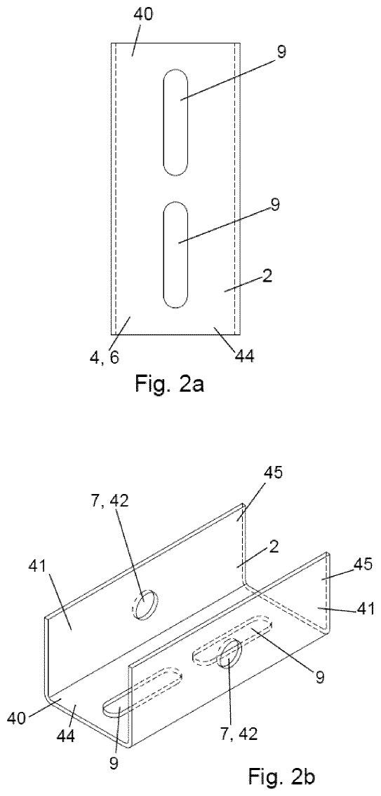

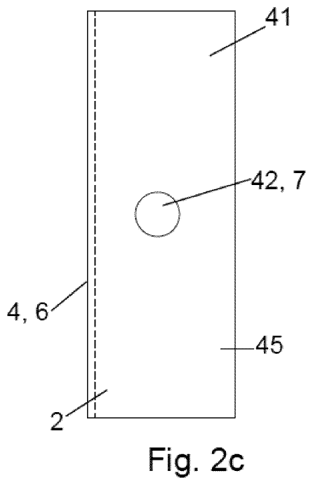

FIG. 2a: a top view of the connecting body of the holder from FIG. 1;

FIG. 2b: a perspective depiction of the connecting body from FIG. 1;

FIG. 2c: a side view of the connecting body from FIG. 1;

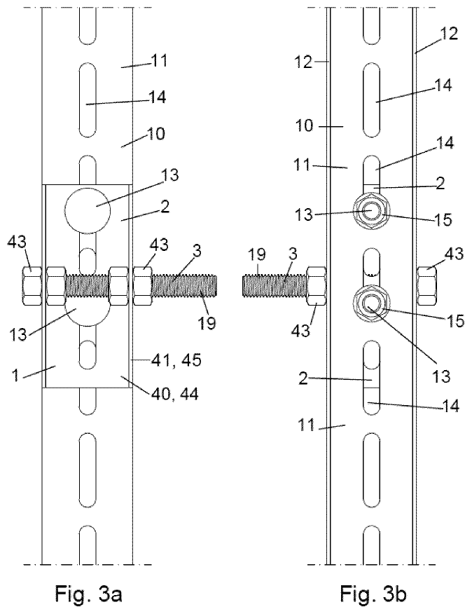

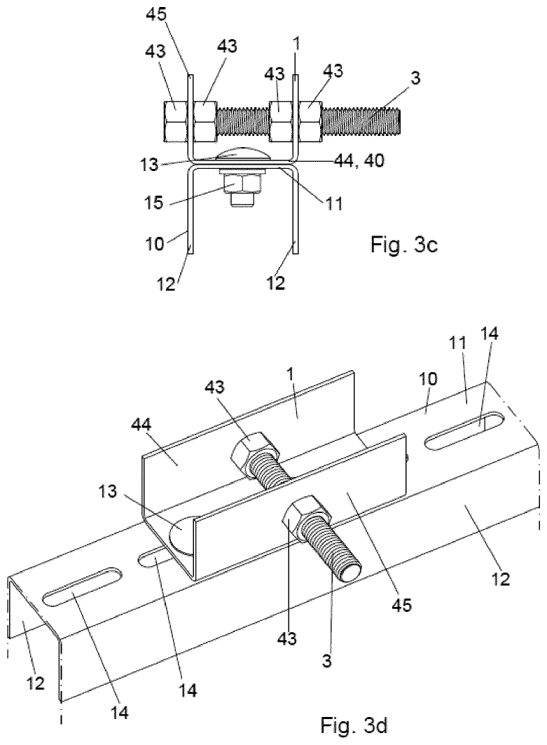

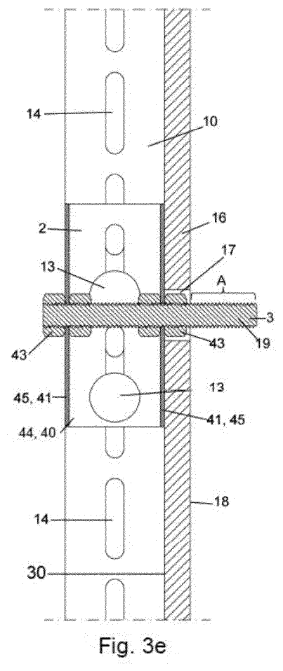

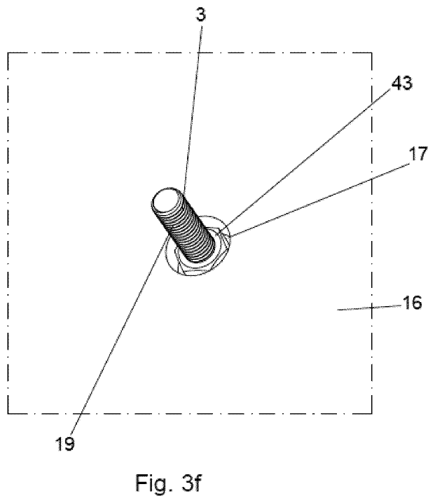

FIG. 3a: a side view of a dry-construction stud of a dry-construction structure with a holder from FIG. 1 fastened thereto from a first side;

FIG. 3b: a side view of the dry-construction stud of the dry-construction structure from FIG. 3a from a second side;

FIG. 3c: a top view of the dry-construction stud with the holder from FIG. 3a fastened thereto;

FIG. 3d: a perspective view of a section of the dry-construction stud with a holder from FIG. 3a fastened thereto;

FIG. 3e: the dry-construction stud from FIG. 3a with a planking arranged on the dry-construction stud;

FIG. 3f: a perspective view in cutout of the dry-construction structure from FIG. 3e;

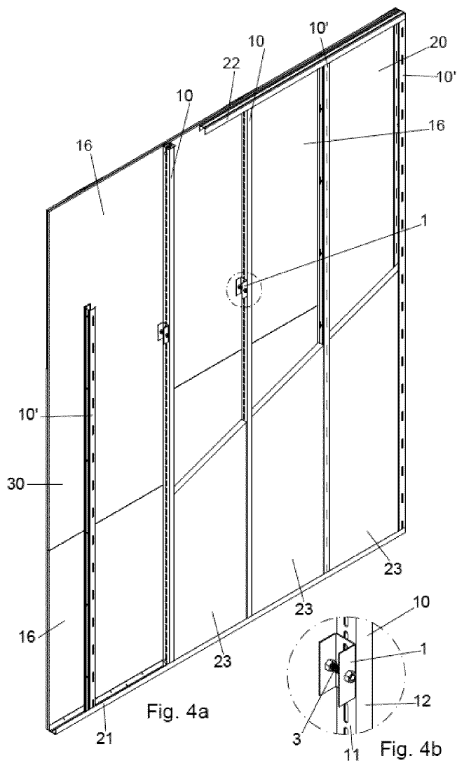

FIG. 4a: a schematic perspective representation, partly in section, of a dry-construction structure with holders according to FIG. 1;

FIG. 4b: an enlarged detail of the dry-construction structure from FIG. 4a;

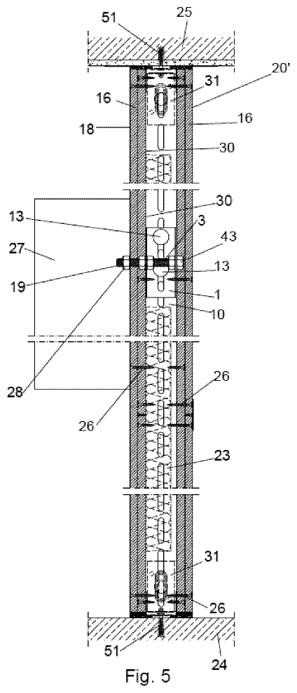

FIG. 5: a schematic sectional representation of a dry-construction structure formed as a partition wall.

FIG. 1 shows a holder 1 for fastening a load to a dry-construction structure that is not depicted.

The holder 1 has a connecting body 2 and a bolt 3. The connecting body 2 is depicted in more detail in the FIGS. 2a to 2c.

The connecting body 2 has a first section 40 and two second sections 41. The second sections 41 are spaced apart by the first section 40 arranged therebetween. Here, the first section 40 forms a connecting section for connecting to a dry-construction stud. For this purpose, the first section 40 has an abutment surface 6 on a first side 4 for abutting against the dry-construction stud. In the depicted exemplary embodiment, the abutment surface 6 is formed flat.

The two second sections 41 are aligned at an angle to the first section 40. In particular, FIG. 2b shows that the second sections 41 are arranged at a right angle to the first section 40.

The connecting body 2 has a bolt receptacle 7. The latter is formed in the second sections 41. For this purpose, openings 42 are formed in the second sections 41. In the assembled state, the bolt 3 extends through the openings 42 (cf. FIG. 1). Here, the two openings 42 in the two second sections 41 are arranged in such a way that the bolt 3 can extend through both openings 42.

For easy fastening, the bolt 3 has an external thread. In the depicted exemplary embodiment, the bolt 3 is arranged with its longitudinal bolt axis parallel to the first section 40 and perpendicular to the second section 41.

The bolt 3 can be provided with at least one nut 43 for connecting to the second section 41. In the depicted exemplary embodiment, the bolt 3 is provided with two nuts 43 arranged on opposite sides of the second section 41. In this way, the bolt 3 can be permanently and safely secured to the connecting body 2. In the depicted exemplary embodiment, two nuts 43 are arranged on each of the two second sections 41. In this way, a particularly stable connection is obtained as the bolt 3 is connected to both second sections 41. Due to the clamping of the second sections 41 between the two nuts 43, a secure and permanent fastening can be achieved.

The bolt 3 can in particular be made of metal, preferably steel. The bolt 3 has a circular cross-section.

The connecting body 2 depicted in the FIGS. 2a to 2c is made of metal. In the depicted exemplary embodiment, the connecting body 2 is bent from a single piece of sheet metal. The material thickness of the connecting body is between 1 mm and 5 mm.

The connecting body has a connecting web 44 and two connecting legs 45. The connecting web 44 forms the first section 40 and the two connecting legs 45 form the second sections 41. The connecting legs 45 are arranged at right angles to the connecting web 44. This results in the shape of a U-profile for the connecting body 2.

The FIGS. 2a to 2c further show that the first section 40 and the second section 41 have a rectangular basic shape.

The connecting body 2 has through-openings 9. In the depicted exemplary embodiment, two through-openings 9 are provided in the first section 40. The through-openings 9 are formed as oblong holes in the depicted exemplary embodiment. First fastening elements 13 can be inserted through the through-openings 9 to fasten the first section 40 of the connecting body 2 to a dry-construction stud 10.

The FIGS. 3a to 3f show the holder 1 fastened to a dry-construction stud 10 of a dry-construction structure in different views.

The depicted dry-construction stud 10 is a dry-construction profile having a web 11 and two legs 12 arranged on the web 11. In the depicted exemplary embodiment, the dry-construction stud is formed as a U-profile. In particular, the dry-construction stud 10 can be designed as a U-stiffening profile. The nominal sheet thickness of the U-profile may in particular be between 1 mm and 5 mm.

FIG. 3a shows a side view of the dry-construction stud 10 from a first side. Here, the view onto the external side of the web 11 of the U-shaped dry-construction stud 10 is depicted.

FIG. 3b shows a side view of the dry-construction stud 10 from a second side. Here, a view from the opposite side, i.e., onto the internal side of the web 11, from the side to which the legs 12 of the dry-construction stud 10 extend, is depicted.

The FIGS. 3a and 3b further show the first fastening elements 13 for connecting the connecting body 2 to the dry-construction stud 10. In the depicted exemplary embodiment, two first fastening elements 13 are provided. These each comprise a screw which extends through the through-openings 9 in the connecting body 2.

The FIGS. 3a and 3b further show that the dry-construction stud 10 has insertion openings 14 in the web 11 for the first fastening elements 13. As depicted, the insertion openings 14 can be formed as slots or oblong holes. In this case, a lower edge of the insertion opening 14 can form a support for the first fastening element 13. Accordingly, as can be seen in FIG. 3b, the first fastening elements 13 are each arranged at the lower end of a insertion opening 14. FIG. 3b further shows that the first fastening elements 13 comprise nuts 15 which are engaged with their nut thread with the screw thread of the screw of the first fastening element 13. In this way, the holder 1 can be braced to the dry-construction stud 10 and thus be securely held. In this case, the connecting body 2 abuts with the abutment surface 6 against the dry-construction stud 10.

In the depicted exemplary embodiment, the screw of the fastening element 13 has an enlarged head. The screw can be formed as a truss head screw as depicted. If the screw has a square neck (not depicted), a form fit can be achieved with the insertion opening 14 of the dry-construction stud 10. In this case, the nut can be screwed onto the bolt without the need for the bolt to be held in place with a tool during assembly. This facilitates the assembly. A washer can be arranged under the nut.

FIG. 3c shows a top view of the dry-construction stud 10 with the holder 1 fastened thereto. FIG. 3c clearly shows the U-shape of the dry-construction stud 10 with the web 11 and the two legs 12. In addition, it is depicted how the holder 1 is fastened to the dry-construction stud 10 by the fastening elements 13. The fastening element 13 comprises the screw which is designed as a truss head screw with a domed head in the depicted exemplary embodiment.

FIG. 3d shows a perspective depiction of the holder 1 fastened to the dry-construction stud 10.

FIG. 3e shows the dry-construction stud 10 from FIG. 3a schematically in section with a planking 16 fastened thereto. In particular, the planking 16 can comprise dry-construction boards, as in particular gypsum boards, gypsum plasterboards, gypsum fibreboards, cement boards, wood boards or wood fibreboards. In FIG. 3e, a single-layer planking 16 is depicted in a schematic manner.

The planking 16 has a recess 17. The bolt 3 extends through the recess 17 of the planking 16.

The planking 16 has a front side 18 facing the room of a house and a rear side 30 facing away from the room. At the front side of the planking, the bolt 3 protrudes with a section 19 by the length A. A load can be securely fastened to section 19. Section 19 can also be clearly seen in FIG. 3f.

The recess 17 is sized such that it can accommodate one of the nuts 43 as depicted in FIG. 3e. In this way, the nut 43 can abut directly against the second section 41. This contributes to its secure fastening of the bolt 3 to the connecting body 2.

The recess 17 around the bolt 3 and the nut 43 can be filled with a preferably elastic fill material, such as silicone (not depicted).

FIG. 3f shows a perspective view of the planking 16 of the dry-construction structure from FIG. 3e. Here, it can be clearly seen that the bolt 3 protrudes in relation to the planking 16.

FIG. 4a shows a schematic perspective representation of a dry-construction structure 20. The dry-construction structure 20 has multiple dry-construction studs 10, 10′ which are arranged spaced apart from each other. In the depicted exemplary embodiment, the dry-construction studs 10, 10′ are formed as vertically arranged dry-construction supports. The dry-construction studs 10, 10′ extend over the entire height of the dry-construction structure 20.

To achieve guidance and alignment, the dry-construction studs 10, 10′ are inserted in a U-profile 21 which is arranged on the underside of the dry-construction structure in a horizontal direction and connected to the floor. Another U-profile 22 is arranged at the upper end of the dry-construction structure 20 and connected to the ceiling. In this case, the ends of the dry-construction studs 10, 10′ are each accommodated between the legs of the U-profiles 21 or 22 and held thereby.

For a better depiction, the U-profile 22 is partially omitted in FIG. 4a, and the dry-construction stud 10′ depicted on the left is depicted in a shortened manner.

The dry-construction structure 20 has the planking 16. In the schematic depiction of FIG. 4a, the planking is depicted as double-layered planking. For a better depiction, the planking 16 is only depicted on one side, the side of the dry-construction structure 20 facing the room. In this form, i.e., with planking 16 on one side, the dry-construction structure 20 can be used as a facing shell placed in front of an existing wall (not depicted). However, the dry-construction structure 20 may also have the planking 16 on both sides of the dry-construction studs 10, 10′ to form a partition wall that can be arranged between two rooms.

FIG. 4a further shows that an insulating material 23 can be accommodated between the dry construction studs 10, 10′. For a better depiction, the insulating material 23 is only shown in a lower region.

The depicted embodiment shows two different dry-construction studs 10 and 10′. The depicted dry-construction studs 10 are the profiles to which the holders 1 are fastened. In particular, the U-profiles also depicted in the FIGS. 3a to 3f can be used here. In particular, the U-profiles can be reinforced, preferably by being formed as U-stiffening profiles. U-stiffening profiles have a greater sheet thickness than simple U-wall profiles or simple C-wall profiles and are therefore more stable. FIG. 4a also shows other dry-construction studs 10′ to which no holders 1 are fastened. For these, the depicted C-wall profiles can be used in particular. Depending on the size of the loads to be accommodated, the holders 1 can also be used on differently formed dry-construction studs. When using U-stiffening profiles for the dry-construction studs 10 to which the holders 1 are fastened, higher loads can be fastened to the dry-construction structure than it is possible with simple U-wall profiles or simple C-wall profiles.

FIG. 4b shows an enlarged cutout of FIG. 4a. Here, it is shown how the holder 1 is arranged on the dry-construction stud 10. The arrangement shown in FIG. 4b corresponds to the arrangement also depicted in FIG. 3a.

In addition, FIG. 4a shows that a holder 1 is arranged on each of two adjacent dry-construction studs 10. This way, two fastening points are available for fastening a load. Thus, even larger console loads can be securely fastened.

FIG. 5 shows a vertical cross-section of a dry-construction structure 20′ formed as a partition wall. The dry-construction structure 20′ has substantially the same elements which have been described in connection with the dry-construction structure 20. Reference is made to the description in this regard.

The dry-construction structure 20′ again has vertically arranged dry-construction studs 10. FIG. 5 further shows the holder 1 fastened to the dry-construction stud 10 with the first fastening elements 13. FIG. 5 further shows the bolt 3 of the holder 1 extending through the planking 16.

The dry-construction structure 20′ is arranged between a floor 24 and a ceiling 25. The dry-construction studs 10 are each fastened to the ceiling 25 and the floor 24 by a connecting angle 31. The connection angles 31 are L-shaped and have two legs. One of the legs is connected to the floor 24 or the ceiling 25 via fastening means 51. The other leg of the connecting angle 31 is secured to the dry-construction stud 10.

The dry-construction structure 20′ has a planking 16 on both sides of the dry-construction studs 10. In the depicted exemplary embodiment, the planking 16 is double-layered on both sides. Also depicted are screws 26 used to fasten the planking 16 to the dry-construction studs 10. In addition, the insulating material 23 is also depicted.

FIG. 5 further shows how a schematically depicted load 27 can be fastened to the dry-construction structure 20′. The load 27 is secured to the bolt 3 by means of a fastening means 28. In the depicted exemplary embodiment, the fastening means 28 is designed as a nut which is screwed onto the bolt 3.

The FIGS. 4a and 5 further show how a load 27 may be fastened to a dry-construction structure 20 and 20′, respectively, comprising dry-construction studs 10.

The holder 1 is fastened to the dry-construction stud 10 with the first fastening elements 13. The bolt 3 is inserted into the bolt receptacle 7 of the holder 1. A recess 17 for the bolt 3 is made in the planking 16. The planking 16 is fastened to the dry-construction studs 10. The above steps are performed in such a way that the bolt 3 of the holder 1 fastened to the dry-construction stud 10 extends through the recess 17 of the planking 16. Finally, the object forming a load 27 can be fastened to the bolt 3.

1. A holder for fastening a load to a dry-construction structure comprising: a connecting body and a bolt; wherein the connecting body has a first section and a second section; wherein the first section forms a connecting section for connecting to a dry-construction stud; wherein in the second section a bolt receptacle is provided for the bolt; and wherein the first section and the second section are arranged at an angle with respect to each other.

2. The holder according to claim 1, characterised in that the connecting body has two second sections which are spaced apart from each other.

3. The holder according to claim 2, characterised in that the connecting body comprises a connecting web and two connecting legs, wherein the connecting web forms the first section and the connecting legs form the second sections.

4. The holder according to claim 1, characterised in that the bolt has a thread and is equipped with at least one nut.

5. The holder according to claim 4, characterised in that the bolt is held with two nuts arranged on opposite sides of the second section wherein the two nuts are braced against each other so that the second section is clamped between the nuts.

6. The holder according to claim 5, characterised in that the bolt is connected to each of the second sections via two nuts respectively.

7. The holder according to claim 1, characterized in that the connecting body is made of one piece of sheet metal.

8. The holder according to claim 1, characterised by a first fastening element for connecting the connecting body to the dry-construction stud.

9. The holder according to claim 8, characterised in that the first section comprises at least one through-opening for the first fastening element

10. A kit for a dry-construction system, comprising a dry-construction stud, and including a holder according to claim 1.

11. A dry-construction structure comprising: at least one dry-construction stud and a planking fastened thereto; wherein the planking has a front side and a rear side; wherein the dry-construction stud is arranged at the rear side of the planking; a holder according to claim 1 which is fastened to the dry-construction stud by a first fastening element; and wherein the bolt of the holder extends through the planking from the rear side to the front side.

12. The dry-construction structure according to claim 11, characterised in that the bolt has a section which protrudes by a length from the front side of the planking.

13. The dry-construction structure according to claim 11, or characterised in that the planking has a recess, wherein the bolt extends through the recess.

14. The dry-construction structure according to claim 13, characterised in that one of the nuts arranged on the bolt is accommodated in the recess.

15. A method of fastening an object to a dry-construction structure comprising a dry-construction stud and a planking comprising the steps of:
fastening of a holder according to claim 1 to the dry-construction stud;
creating a recess in the planking; and
arranging the planking on the dry-construction stud;
wherein this is done in such a way that the bolt of the holder extends through the recess of the planking and wherein the object is fastened to the bolt.
